(19) United States
(12) Patent Application Publication
(10) Pub. No.: US 2020/0410606 A1
(43) Pub. Date: Dec. 31, 2020

(54) METHODS AND SYSTEMS FOR CREATING A DIGITAL BUSINESS CARD

(71) Applicant: REAL GRADER, INC., Fairfield, CT (US)

(72) Inventors: Lorin Daniel RADU, Weston, CT (US); Alex MONTALENTI, Miami Beach, FL (US)

(21) Appl. No.: 16/914,356

(22) Filed: Jun. 27, 2020

Related U.S. Application Data
(60) Provisional application No. 62/867,887, filed on Jun. 28, 2019.

(51) Int. Cl. G06Q 50/00; G06Q 10/10; G06Q 30/02; G06F 16/22; G06F 16/9535; H04L 29/08

(52) U.S. Cl. CPC G06Q 50/01; G06Q 10/109; G06Q 10/107; H04L 67/02; G06F 16/22; G06F 16/9535; H04L 67/306; G06Q 30/0282

(57) ABSTRACT

Methods and systems for creating a digital business card in form of a progressive web application. The method includes receiving user profile information. The user profile information includes personal information and one or more of: one or more social media links; one or more photos; and one or more videos. The method includes creating a digital business card for a user based on the received user profile information. The digital business card is a microsite created in form of one or more progressive web pages. The method further includes facilitating sharing of the digital business card with one or more individuals by the user.

### TECHNICAL FIELD

Embodiments of the disclosure relate generally to a field of personal information management and, more particularly to, methods and systems for creating a digital business card in form of a progressive web application.

### BACKGROUND

Business cards are a part of a person's introduction and are important for making a favorable first impression. An attractive, eye-catching business card with all relevant contact information captures the attention of customer(s) after the initial meeting. Traditionally, paper cards are used as business cards. The paper business cards are created in such a way that they reflect the personality of a person associated with the business card, and a hue of colors may be used to add the personality component in the business card. The personalized feel stands to be an unbeatable tool of human networking. However, in today's digital era, paper cards are getting slowly replaced with digital business cards.

A digital business card provides a modern way to exchange information with potential customers. They can be easily saved and updated without wasting time, money, and effort. Further, they enhance peer-to-peer interaction with several features. For instance, embedded video(s) and integrated calendar applications facilitate a seamless way to follow up with the customers and so on. Additionally, there is no limitation with respect to the information that can be stored in the business card as unlike paper cards, there is no lack of space. Digital business cards can be easily shared with people through Text (SMS), Email, QR Code, Twitter™, Facebook Messenger, WhatsApp™, Facebook™, and LinkedIn®. There are multiple types of digital business cards based on different platforms, technologies, and devices.

Although digital business cards are very useful, they do have several drawbacks. Digital cards appear far less personal and lack design options which makes them less user-friendly. Further, to create digital cards, users are required to download and install appropriate apps. It is a slightly tedious process as compared to paper cards, where one can simply hand over a card to a customer in no time. Furthermore, the customer also needs to access the Internet to create, send and/or view digital cards. It is basically impossible to access digital cards if either the user or the customer is in a situation where Internet is unavailable.

In light of the above discussion, there is a need for methods and systems that create more personalized and user-friendly digital business cards while ensuring shareability of the created digital business cards electronically during business interactions, and eliminating dependence on the Internet for viewing the shared digital business card.

### SUMMARY

Various embodiments of the present disclosure provide methods and systems for creating a digital business card in form of a progressive web application.

In an embodiment, a method includes receiving user profile information. The user profile information includes personal information and one or more of: one or more social media links; one or more photos; and one or more videos. The method includes creating a digital business card for a user based on the received user profile information. The digital business card is a microsite created in form of one or more progressive web pages. The method further includes facilitating sharing of the digital business card with one or more individuals by the user.

In another embodiment, a server system includes a memory to store instructions and a processor to execute the stored instructions in the memory. The processor is configured to execute the instructions to cause the server system, at least in part, to receive user profile information. The user profile information includes personal information and one or more of: one or more social media links; one or more photos; and one or more videos. The server system is further configured to create a digital business card for a user based on the received user profile information. The digital business card is a microsite created in form of one or more progressive web pages. The server system is further configured to facilitate sharing of the digital business card with one or more individuals by the user.

In yet another embodiment, a method includes receiving marketable entity profile information. The marketable entity profile information includes marketable entity information, and one or more of: one or more social media links associated with a marketable entity; one or more photos associated with the marketable entity; and one or more videos associated with the marketable entity. The method includes creating a digital business card based on the received marketable entity profile information. The digital business card is a microsite created in form of one or more progressive web pages. The method further includes facilitating sharing of the digital business card with one or more individuals by a person handling the marketable entity.

### BRIEF DESCRIPTION OF THE FIGURES

For a more complete understanding of example embodiments of the present technology, reference is now made to the following descriptions taken in connection with the accompanying drawings in which:

FIG. 1 is an illustration of an environment, where at least some example embodiments can be practiced;

FIG. 2 is a block diagram of a system for creating a digital business card in form of a progressive web application, in accordance with an example embodiment;

FIG. 3 is a flowchart illustrating a method for creating a digital business card, in accordance with an example embodiment;

FIG. 4 is a flowchart illustrating a method for creating a digital business card for a marketable entity, in accordance with another example embodiment;

FIG. 5A is an example representation of a user interface (UI) depicting a basic information page of an online questionnaire, in accordance with an example embodiment;

FIG. 5B is an example representation of a UI depicting an image page of the online questionnaire, in accordance with an example embodiment;

FIG. 5C is an example representation of a UI depicting an account management page, in accordance with an example embodiment;

FIG. 6A is an example representation of a UI depicting a digital business card page, in accordance with an example embodiment;

FIG. 6B is an example representation of the UI depicting a digital shared page, in accordance with an example embodiment;

FIG. 6C is an example representation of the UI depicting a contacts page, in accordance with an example embodiment;

FIG. 6D is an example representation of the UI depicting a connect with me page, in accordance with an example embodiment;

FIG. 6E is an example representation of the UI depicting a review page, in accordance with an example embodiment;

FIG. 6F is an example representation of the UI depicting a review me page, in accordance with an example embodiment;

FIG. 6G is an example representation of the UI depicting a recommendation page, in accordance with an example embodiment;

FIG. 7A is an example representation of a digital business card created for a marketable entity, in accordance with an example embodiment;

FIG. 7B is an example representation of the digital business card displayed in a mobile view, in accordance with an example embodiment;

FIG. 8 is an example representation of a digital business card created for another marketable entity, in accordance with an example embodiment;

FIG. 9 is a block diagram of an electronic device capable of implementing the various embodiments of the present disclosure, in accordance with an example embodiment; and

FIG. 10 is a block diagram of a server system of FIG. 1, in accordance with an example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide methods and systems for creating a digital business card in form of a progressive web application.

A progressive web application generation platform is provided for creating a digital business card in form of a progressive web application. The progressive web application generation platform provides User Interfaces (UI's) that help user in creating the digital business card that is a microsite created in form of one or more progressive web pages.

The progressive web application generation platform first receives user profile information associated with a user by asking the user to fill an online questionnaire and then creates a digital business card based on the user profile information provided by the user in the online questionnaire. The user profile information includes personal information, such as name, address, designation, company name etc., and one or more social media links, one or more photos and one or more videos associated with the user. The created digital business card is then available to the user. The user thereafter now shares the created digital business card with other individuals, such as his/her customers or other contacts.

The created digital business card is basically a microsite created in form of one or more progressive web pages. So, the customer viewing the digital business card is not required to download the progressive web application generation platform for viewing the shared digital business card of the user. The progressive web application generation platform facilitates a plurality of operations to be performed by the customer on the digital business card. The operations that can be performed includes making a call to the user, sending a text to the user, sending an e-mail to the user, accessing one or more social media links included in the digital business card, adding the digital business card as a contact on the mobile device, sharing the digital business card with other individuals, and writing and viewing reviews of the user.

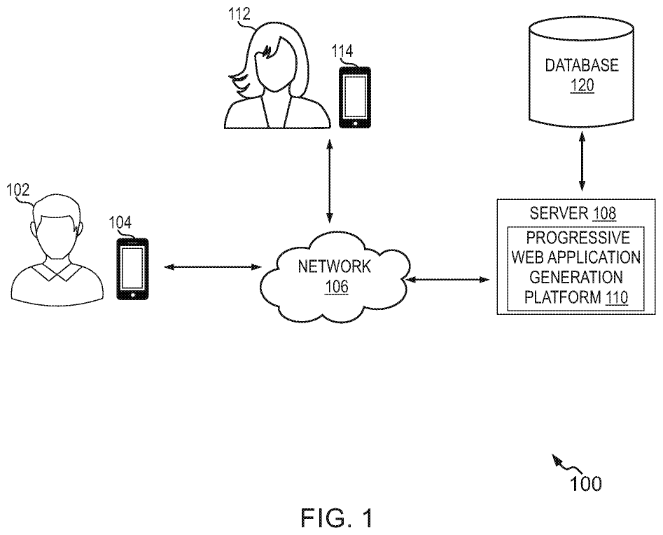

FIG. 1 is an illustration of an environment 100 related to at least some example embodiments of present disclosure. The environment 100 includes, but is not limited to, a wireless communication network (e.g., a network 106) that connects entities such as a user 102, a customer 112 and a server 108. The user 102 is depicted to be associated with an electronic device 104 (hereinafter referred to as ‘user device 104’). The customer 112 is depicted to be associated with an electronic device 114 (hereinafter referred to as ‘customer device 114’). The user 102 can be a sales person working for a consumer goods company or any person who wants to create a digital business card for business purposes. The customer 112 can be a client/customer of the user 102 with whom the user 102 wants to share his digital business card for performing professional/business interactions. It should be noted that the one user and one customer are shown for the sake of simplicity to explain the present disclosure; in application, there will be many such users and customers.

In an embodiment, the user device 104 is equipped with a progressive web application generation platform 110 that facilitates creation of a digital business card for the user 102 in form of one or more progressive web pages. The user device 104 may be any communication device having hardware components for enabling User Interfaces (UIs) of the progressive web application generation platform 110 to be presented on the user device 104. The user device 104 and the customer device 114 may be capable of being connected to a wireless communication network (such as the network 106). Examples of the user device 104 and the customer device 114 include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like.

In at least one example embodiment, the user 102 may access the progressive web application generation platform 110 for creating a digital business card. The progressive web application generation platform 110 is a progressive web application (PWA) generation platform i.e. applications generated using the progressive web application generation platform 110 are progressive web applications that are different from the normal web applications. Some functionalities of the PWA may include working offline, push notifications, hardware access of the device etc. To access the PWA, the user is free from downloading and installing the application to access a website. However, the PWAs obtain all the user permissions that are required just like a normal web application installation.

For creating the digital business card using the progressive web application generation platform 110, the user 102 is required to provide user profile information. The user profile information includes personal information associated with the user 102, such as name of the user 102, address of the user 102, contact information of the user 102, short bio about the user 102, and electronic email (e-mail) address of the user 102. In an embodiment, the short bio may include information such as current designation of the user, name of the company in which the user is working etc. The user profile information may also include one or more social media links, such as Facebook™ profile link, Instagram™ profile link, LinkedIn® profile link etc., one or more photos and one or more videos associated with the user 102.

In an embodiment, the server 108 provides a software application, herein referred to as the progressive web application generation platform 110, in response to request received from the user device 104 via the network 106. Examples of the network 106 include stand alone or a combination of a local area network (LAN), a wide area network (WAN), wireless, wired, any currently existing or to be developed network that can be used for communication. More specifically, an example of the network 106 can be the Internet which may be a combination of a plurality of networks. In some embodiments, the progressive web application generation platform 110 may be factory-installed on the user device 104 and the user 102 may not need to specifically request the progressive web application generation platform 110 from the server 108.

In at least one example embodiment, the progressive web application generation platform 110 is configured to display an online questionnaire on the user device 104 that needs to be filled by the user 102 for creating the digital business card. The online questionnaire is used to receive user profile information and may include one or more sections, such as a “basic information” section for receiving personal information (e.g., name, bio details, contact information, email id) of the user 102, a social media link section for receiving profile links of one or more social media platforms, an images section where the user 102 can upload one or more photos and the one or more videos etc. The progressive web application generation platform 110 is also configured to record the user profile information provided by the user 102 in a database 120 associated with the server 108.

Further, the progressive web application generation platform 110 is configured to create the digital business card for the user 102 based on the user profile information received through the online questionnaire. In an embodiment, the created digital business card is a microsite created in form of one or more progressive web pages. The microsite is an individual web page or a small group of web pages that are rather simple and easy to navigate unlike regular websites. Typically, the microsite functions as a discrete entity within a website and/or complements an offline activity. In general, microsites are used for a specific task like promoting a particular brand, product or service. Specifically, in current scenario, the microsite is developed with progressive web pages offered by the PWA, thus the functionalities of the PWA are also available with the developed microsite, such as offline availability of the microsite.

In an embodiment, the progressive web application generation platform 110 may enable the user 102 to share the created digital business card with one or more individuals, such as the customer 112. In an embodiment, the progressive web application generation platform 110 may generate a link for the created digital business card and may provide the link to the user 102. The user 102 can directly use the generated link to share the created digital business card with other individuals, such as the customer 112 using contact information of the customer 112. In another embodiment, the created digital business card also provides a share option that can be used by the user 102 to share the digital business card with other individuals, such as the customer 112. The individuals can also further share the digital business card with other individuals. The progressive web application generation platform 110 also includes a tracking mechanism for tracking number of times the created digital business card is being shared and to whom the created digital business card is being shared. The progressive web application generation platform 110 enables the user to see the number of times his/her digital business card is shared and with whom.

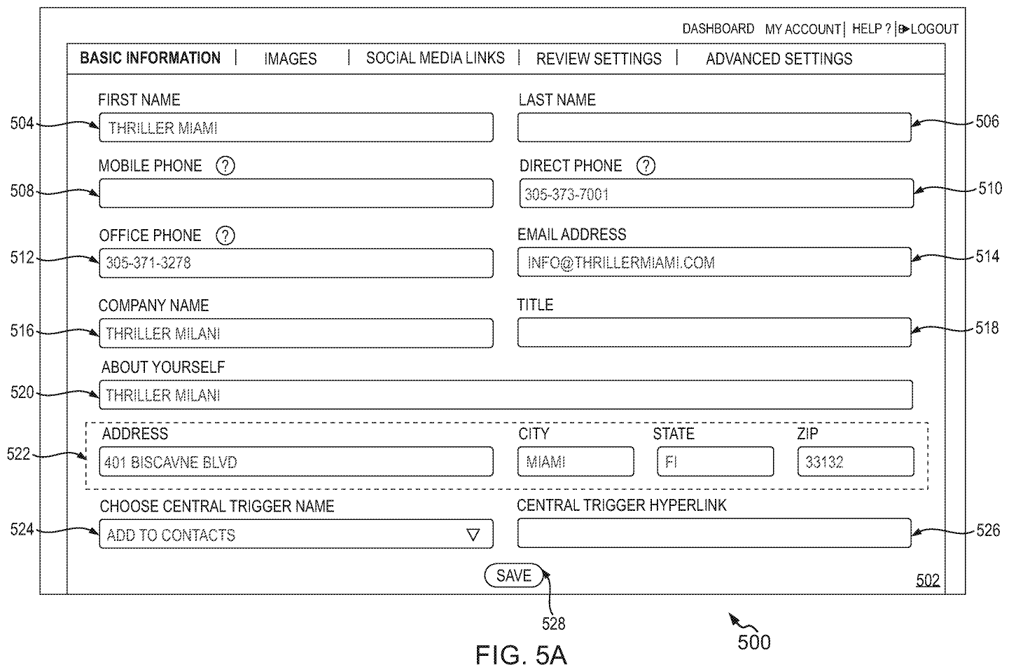

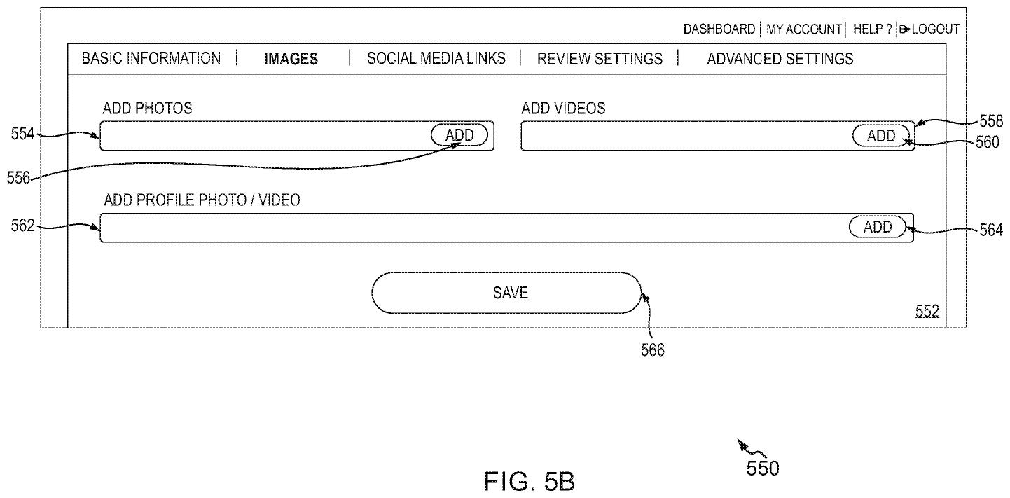

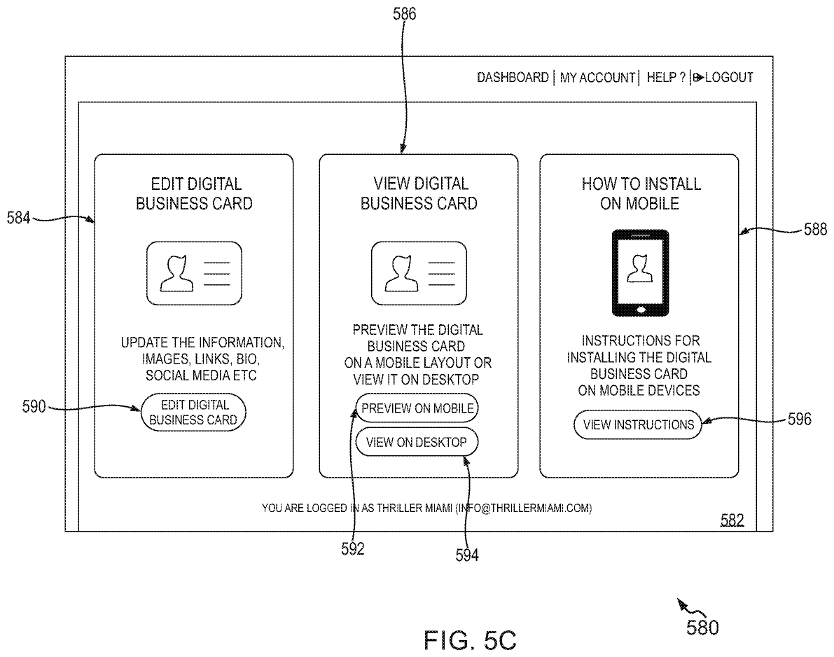

Further, the progressive web application generation platform 110 may enable the user 102 to update the user profile information (see, FIG. 5C) to generate an updated digital business card in case the user 102 wants to update any information included in the created digital business card.

In an embodiment, the customer 112, upon receiving the link of the digital business card shared by the user 102 on the customer device 114, may open the digital business card of the user 102 by clicking on the link received on the customer device 114. The customer 112 is not required to download and install the progressive web application generation platform 110 for viewing the digital business card shared by the user 102. A web browser available in the customer device 114 may directly request the digital business card from the server 108 using the network 106. The server 108, upon receiving the request, may display the digital business card (microsite) on the customer device 114. The customer 112 can now view the digital business card on the customer device 114. The customer 112 is also allowed to perform one or more actions on the displayed digital business card using functions of the customer device 114 as the functions of the customer device 114 are retrieved by an application programming interface (API) that is synchronized with the progressive web application generation platform 110 providing the digital business card. The one or more actions that can be performed by the customer 112 on the digital business card include accessing one or more social media links included in the digital business card, adding the digital business card as a contact on the customer device 114, sharing the digital business card, sending a text to the user 102, making a call to the user 102, sending an e-mail to the user 102, and writing and viewing reviews for the user 102.

The progressive web application generation platform 110 is an application resting at the server 108. In an embodiment, the server 108 is configured to manage the progressive web application generation platform 110 and communicate with devices, such as the user device 104 and the customer device 114 using the network 106. The progressive web application generation platform 110 may be accessed through the web via the network 106. In an embodiment, the progressive web application generation platform 110 may be accessed through the web using Internet.

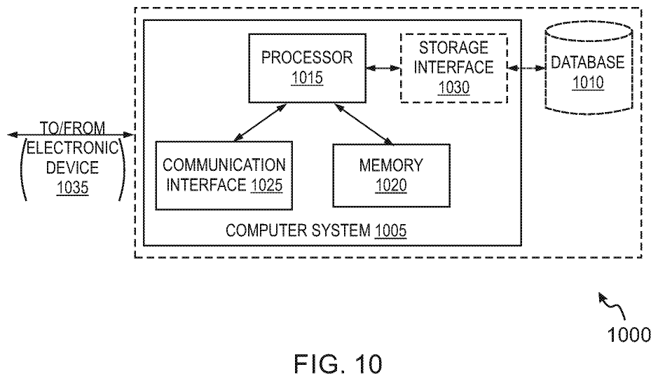

It is noted that the instructions (or the executable code) configuring the progressive web application generation platform 110 are stored in a memory of the server 108, and the instructions are executed by a processor (for example, a single-core or a multi-core processor) included within the server 108, as is exemplarily shown with reference to FIG. 10. Accordingly, even though the various functionalities for creating the digital business card are explained with reference to or being performed by the progressive web application generation platform 110, it is understood that the processor in conjunction with the code in the memory is configured to execute the various tasks as enabled by the instructions of the progressive web application generation platform 110.

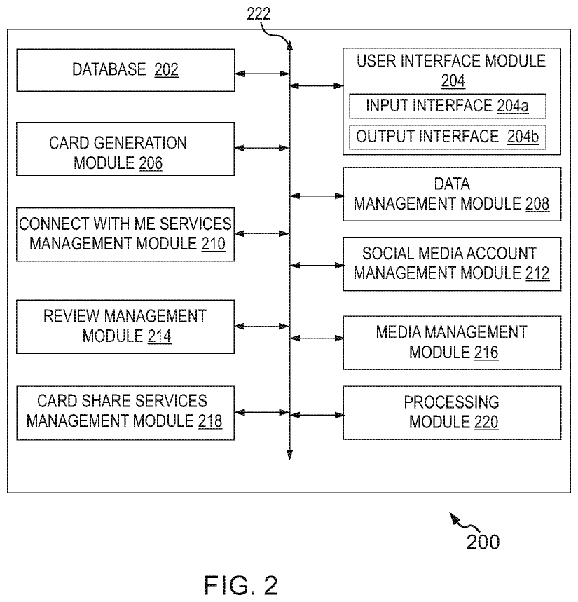

The various components of the progressive web application generation platform 110 are further explained with reference to FIG. 2.

FIG. 2 is a block diagram of a system 200 for creating a digital business card in form of a progressive web application, in accordance with an example embodiment. The system 200 is configured to generate and manage the digital business cards. In an embodiment, the system 200 includes a database 202, a user interface (UI) module 204, a card generation module 206, a data management module 208, a connect-with-me services management module 210, a social media account management module 212, a review management module 214, a media management module 216, a card share services management module 218, a processing module 220 and a centralized circuit system 222.

The database 202 is configured to store user profile information associated with each user of one or more users (e.g., the user 102). The user profile information includes personal information of the user and one or more of: one or more social media links; one or more photos; and one or more videos. The database 202 is also configured to store reviews posted by the individuals on the digital business card of each user.

The UI module 204 is in communication with the database 202. The UI module 204 is configured to present one or more UIs for facilitating creation and management of the digital business card. The UI module 204 includes an input interface 204a and an output interface 204b. The input interface 204a is configured to receive the user profile information associated with each user. The input interface 204a is also configured to receive display mode information for sharing the digital business card with an individual of the one or more individuals. Further, the input interface 204a is configured to receive reviews written by individuals on the digital business card of each user. Additionally, the input interface 204a is configured to receive request for viewing the digital business card from the one or more individuals. Examples of the input interface 204a may include but are not limited to, a keyboard, a mouse, a joystick, a keypad, a touch screen, soft keys, a floppy disk, a pen drive, a hard drive and the like. The output interface 204b is configured to facilitate display of the digital business card to the one or more individuals. The output interface 204b is also configured to facilitate sharing of the digital business card with the one or more individuals. Further, the output interface 204b is configured to allow one or more actions to be performed on the digital business card by the individual. Additionally, the output interface 204b is configured to facilitate display of the number of shares performed for the digital business card along with the name of individuals with whom the digital business card is being shared. Examples of the output interface 204b may include, but are not limited to, a display such as a light emitting diode (LED) display, a thin-film transistor (TFT) display, a liquid crystal display, an active-matrix organic light-emitting diode (AMOLED) display, and the like. In an embodiment, the input interface 204a and the output interface 204b are based on application programming interfaces (APIs). In an example, the input interface 204a can receive input data and the output interface 204b can provide output data via API calls.

The card generation module 206 is in communication with the database 202. The card generation module 206 is configured to generate the digital business card for each user based on the user profile information received for the corresponding user. The data management module 208 is in communication with the database 202 and the card generation module 206. The data management module 208 is configured to manage the user profile information included in the digital business card created for each user of the one or more users. The management of the user profile information includes management of the updates performed by each user on the digital business card of the corresponding user.

The connect-with-me services management module 210 is configured to manage different connecting options provided by the created digital business card. The connecting options provided by the digital business card include connect over phone, connect over messages, connect over email and add to contacts. The connect-with-me services management module 210 is configured to synchronize electronic device functions with the created digital business card to allow the connecting options, such as messaging, calling etc. provided on the created digital business card to be used by the individuals viewing the digital business card on their electronic devices. For example, the digital business card displayed on the electronic device (e.g., the customer device 114) associated with the individual (e.g., the customer 112) may include a call icon that can be clicked by the individual to connect with the user associated with the digital business card. So, clicking on the call icon may use general call feature of the electronic device for making a call to the user. Similarly, clicking on the messaging icon may use messaging feature of the electronic device for sending a message to the user.

The social media account management module 212 is in communication with the database 202. The social media account management module 212 is configured to manage the social media links included in the digital business card. The social media account management module 212 is also responsible for redirecting the individual viewing the digital business card to a social media profile of the user once the individual clicks on a corresponding social media icon displayed on the digital business card. For example, if the individual clicks on the Facebook™ icon displayed on the digital business card, the individual may be redirected to the Facebook™ profile of the user.

The review management module 214 is in communication with the database 202. The review management module 214 is configured to manage one or more reviews posted by each individual of the one or more individuals on the digital business card of each user (e.g., the user 102). The review management module 214 is also configured to pull reviews posted about the user from other user's profiles, such as LinkedIn® profile and display the pulled reviews in the digital business card. The review management module 214 may use various techniques for pulling the reviews, for instance, an API can be used or specific review pages of the different user profiles may be linked with the digital business card. In an embodiment, the reviews displayed on the digital business card of the user are either related to work experience or related to the user or can be recommendations for the user. The reviews are generally dependent on a social media platform from where the review has been taken, for example work experience review can be taken from the LinkedIn® profile of the user.

The media management module 216 is in communication with the database 202. The media management module 216 is configured to manage media, such as one or more pictures and the one or more videos added by each user in their digital business card. The management of media includes management of profile photo, management of background photo, video or slideshow, and the management of logo. In an embodiment, the logo can be a company logo with which the user is working. The media management module 216 is also configured to brand a corresponding website with the logo that is added in the digital business card. For example, if a user (e.g., the user 102) has added an ‘XYZ’ company logo on the digital business card, then an original website of the corresponding company will also be linked with the added logo. So, a customer (e.g., the customer 112) viewing the digital business card can be redirected to the corresponding company's website in case the customer clicks on the company's logo added by the user.

The card share services management module 218 is configured to manage sharing of the digital business card by each user. The card share services management module 218 is configured to synchronize with one or more messaging platforms, such as WhatsApp™ messenger, Facebook™ messenger, messaging application, Google hangout etc. available in user device of the each user to facilitate sharing of the digital business card through the messaging platforms. The card share services management module 218 is also configured to track the sharing of the digital business card. Here, by tracking, we mean tracking of the number of shares performed for the digital business card and tracking of the individuals with whom the digital business card is being shared.

The processing module 220 is in communication with the database 202, the UI module 204, the card generation module 206, the data management module 208, the connect-with-me services management module 210, the social media account management module 212, the review management module 214, the media management module 216 and the card share services management module 218. The processing module 220 is configured to send operating instructions to the database 202, the UI module 204, the card generation module 206, the data management module 208, the connect-with-me services management module 210, the social media account management module 212, the review management module 214, the media management module 216 and the card share services management module 218 for facilitating creation and management of the digital business card by the system 200.

The database 202, the UI module 204, the card generation module 206, the data management module 208, the connect-with-me services management module 210, the social media account management module 212, the review management module 214, the media management module 216, the card share services management module 218 and the processing module 220 may be configured to communicate with each other via or through the centralized circuit system 222. The centralized circuit system 222 may be various devices configured to, among other things, provide or enable communication among the modules (202-220) of the system 200. In certain embodiments, the centralized circuit system 222 may be a central printed circuit board (PCB) such as a motherboard, a main board, a system board, or a logic board. The centralized circuit system 222 may also, or alternatively, include other printed circuit assemblies (PCAs) or communication channel media. In some embodiments, the centralized circuit system 222 may include appropriate storage interfaces to facilitate communication among the modules (202-220). Some examples of the storage interface may include, for example, an Advanced Technology Attachment (ATA) adapter, a Serial ATA (SATA) adapter, a Small Computer System Interface (SCSI) adapter, a RAID controller, a SAN adapter or a network adapter.

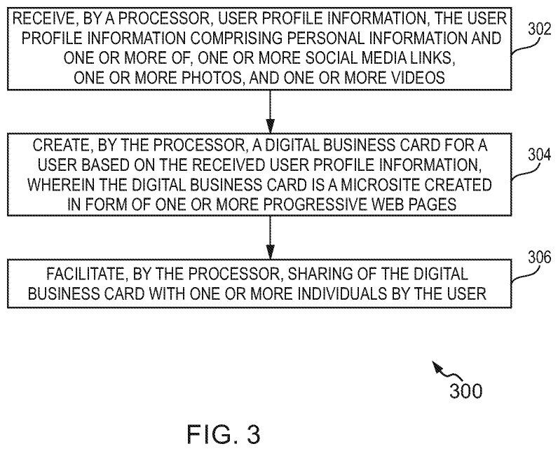

FIG. 3 is a flowchart illustrating a method 300 for creating a digital business card, in accordance with an example embodiment. The operations of the method 300 may be carried out by the progressive web application generation platform 110 included in the server 108 or the system 200. The sequence of operations of the method 300 may not to be necessarily executed in the same order as they are presented. Further, one or more operations may be grouped together and performed in form of a single step, or one operation may have several sub-steps that may be performed in parallel or in sequential manner.

At operation 302, the method 300 includes receiving, by a processor, user profile information. The user profile information that will be used to create the digital business card is received. An online questionnaire (shown in FIGS. 5A-5B) may be presented by the progressive web application generation platform 110 on a user device (e.g., the user device 104) for receiving the user profile information associated with a user (e.g., the user 102) who wants to create the digital business card. The user profile information includes personal information, such as name of the user, designation of the user, company name, contact information, email-id etc. The user profile information may also include one or more of social media links of profile of the corresponding user; one or more photos that the user wants to display in the digital business card; and one or more videos. The received user profile information is further stored in a database (e.g., the database 120).

At operation 304, the method 300 includes creating, by a processor, a digital business card for the user based on the received user profile information. The created digital business card is basically a microsite created in form of one or more progressive web pages.

At operation 306, the method 300 includes facilitating, by the processor, sharing of the digital business card with one or more individuals by the user. Once the digital business card is created for the user, the progressive web application generation platform 110 may facilitate sharing of the created digital business card by the user to one or more individuals (e.g., the customer 112). In an embodiment, for facilitating sharing of the digital business card, the progressive web application generation platform 110 may generate a Uniform Resource Locator (URL)/web address for the created digital business card and may provide the generated URL to the user. The user can share the generated URL with other individuals using any messaging platform. In another embodiment, for facilitating sharing of the digital business card, a sharing option is provided in the created digital business card that is displayed on the user device. The user can use the sharing option directly from the displayed digital business card to share the digital business card with other individuals. In some embodiments, the digital business card can be shared by the user with each individual of the one or more individuals in an access mode. The access mode is one of: a private mode; and a public mode. In private mode, the user can share different or additional information with specific individuals for instance, cell phone or home phone instead of just business phone. The additional information may be available on a private URL created by the progressive web application generation platform 110 for a limited amount of time.

In an embodiment, once the user shares the digital business card with an individual (e.g., the customer 112), the individual may receive the URL associated with the digital business card of the user on his/her mobile device. The individual may then click on the URL received on his mobile device to view the digital business card of the user. As the created digital business card is basically the microsite created in form of one or more progressive web pages, the individuals are not required to download the progressive web application generation platform 110 for viewing the digital business card.

Clicking on the URL by the individual, may generate and send a request to view the digital business card to the server 108. The server 108, upon receiving the request, may facilitate display of the digital business card on the mobile device associated with the individual. The server 108 may also allow one or more actions to be performed on the displayed digital business card by the individual. The one or more actions that can be performed by the individuals include accessing one or more social media links included in the digital business card, adding the digital business card as a contact on the mobile device, sharing the digital business card, sending a text to the user, making a call to the user, sending an e-mail to the user and writing and viewing reviews for the user. If the individual chooses to add the digital business card as a contact on the mobile device, the user profile information included in the digital business card will be added in contact information.

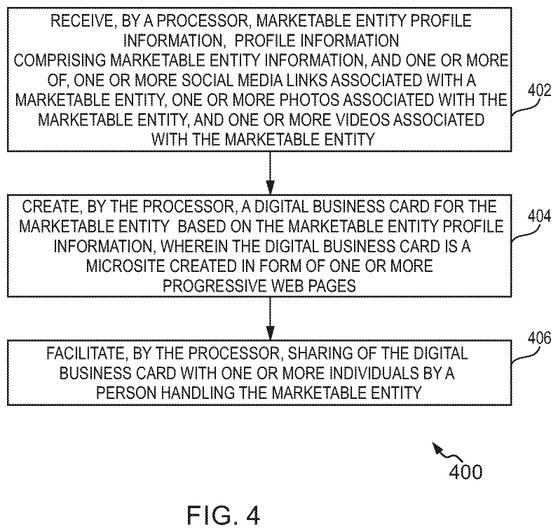

FIG. 4 is a flowchart illustrating a method 400 for creating a digital business card for a marketable entity, in accordance with another example embodiment. The method 400 is performed when a marketable entity wants to create a digital business card for running a marketing campaign. The operations of the method 400 may be carried out by the progressive web application generation platform 110 included in the server 108 or the system 200. The sequence of operations of the method 400 may not to be necessarily executed in the same order as they are presented. Further, one or more operations may be grouped together and performed in form of a single step, or one operation may have several sub-steps that may be performed in parallel or in sequential manner.

At operation 402, the method 400 includes receiving, by a processor, marketable entity profile information. The profile information associated with the marketable entity for which the digital business card is to be created is received. Examples of the marketable entity include, but are not limited to companies, products, campaigns, events etc. An online questionnaire may be presented by the progressive web application generation platform 110 on an electronic device of a person handling the marketable entity for receiving the marketable entity profile information. The marketable entity profile information depends on a type of the marketable entity. For example, in case the marketable entity is a company, marketable entity profile information may include information associated with the company, such as company name, main products/services offered by that company etc. Similarly, in case the marketable entity is an event, the marketable entity profile information may include event name, location where the event is happening, name of a company organizing the event, contact information, email-id etc. Generally, the marketable entity profile information includes marketable entity information, such as name of the marketable entity, address details, contact information etc. The marketable entity profile information may also include one or more of social media links of pages of the corresponding marketable entity; one or more photos associated with the marketable entity; and one or more videos associated with the marketable entity. The received marketable entity profile information is further stored in a database (e.g., the database 120).

At operation 404, the method 400 includes creating, by a processor, a digital business card based on the received marketable entity profile information. The created digital business card is basically a microsite created in form of one or more progressive web pages.

At operation 406, the method 400 includes facilitating, by the processor, sharing of the digital business card with one or more individuals by one or more persons handling the marketable entity. Once the digital business card is created for the marketable entity, the progressive web application generation platform 110 may facilitate sharing of the created digital business card by the one or more persons handling the marketable entity to one or more individuals. In an embodiment, for facilitating sharing of the digital business card, the progressive web application generation platform 110 may generate a Uniform Resource Locator (URL)/web address for the created digital business card and may provide the generated URL to the one or more persons. The one or more persons can share the generated URL with other individuals using any messaging platform. In another embodiment, for facilitating sharing of the digital business card created for the marketable entity, a sharing option is provided in the created digital business card that is displayed on electronic devices associated with the one or more persons. Each person of the one or more persons can use the sharing option directly from the displayed digital business card to share the digital business card with other individuals. In some embodiments, the digital business card can be shared by the person with each individual of the one or more individuals in an access mode. The access mode is one of: a private mode; and a public mode.

In an embodiment, once the person shares the digital business card with an individual, the individual may receive the URL associated with the digital business card of the marketable entity on his/her mobile device. The individual may then click on the URL received on his mobile device to view the digital business card of the marketable entity. As the created digital business card is basically the microsite created in form of one or more progressive web pages, the individuals are not required to download the progressive web application generation platform 110 for viewing the digital business card of the marketable entity.

Clicking on the URL by the individual, may generate and send a request to view the digital business card to the server 108. The server 108, upon receiving the request, may facilitate display of the digital business card on the mobile device associated with the individual. The displayed business card may include a central trigger for action depending on a type of the marketable entity. For example, in case the marketable entity is an ‘event’, the central trigger for action can be ‘Buy Tickets’ or ‘Register Today’. Similarly, in case the marketable entity is a tourism company, the central trigger for action can be ‘Browse attractions’ or ‘Make a Trip’. The server 108 may also allow one or more actions to be performed on the displayed digital business card by the individual. The one or more actions also depend on the marketable entity. For example, if the marketable entity is a ‘property for sale’, then one or more actions that can be performed by the individuals include viewing video associated with the property, accessing one or more social media pages of the property, sending a text to the property owner, making a call to the property owner, sending an e-mail to the property owner, writing reviews for the property or viewing reviews of the property.

FIG. 5A is an example representation of a user interface (UI) 500 depicting a basic information page 502 of an online questionnaire displayed to a user, such as the user 102 of the progressive web application generation platform 110, in accordance with an example embodiment. The UI 500 is presented on a user device, such as the user device 104 shown in FIG. 1. In an embodiment, the user may be required to register first with the progressive web application generation platform 110 by providing an e-mail id or a contact number for using the progressive web application generation platform 110. Once the user is registered, a user dashboard is created for the user. The user dashboard may include one or more pages, such as a basic information page, an image page and a social media link page for collecting user profile information in form of the online questionnaire that the user needs to fill. The one or more pages may also include some additional setting pages, such as a review setting and an advanced setting page apart from the online questionnaire for taking user inputs for adjusting display and privacy settings associated with a digital business card that is to be created for the user/marketable entity. The basic information page is used to receive personal/marketable entity information associated with the user/marketable entity which will be used by the progressive web application generation platform 110 for creating the digital business card for the user/marketable entity.

The basic information page 502 includes a first name field 504, a last name field 506, a mobile phone field 508, a direct phone field 510, an office phone field 512, an email-id field 514, a company name field 516, a title field 518, an about yourself field 520, an address field 522, a central trigger name field 524, a central trigger hyperlink field 526 and a save button 528. The user can provide a first name of the user for whom the digital business card needs to be created in the first name field 504 and the last name of the user in the last name field 506. In case of the marketable entity, the name of the marketable entity will be provided in the first name field 504.

The mobile phone field 508, the direct phone field 510, the office phone field 512 and the email-id field 514 are used by the user for providing primary, alternate and office contact numbers and the email-id, respectively. The user can provide a name of an organization with which the user is currently working in the company name field 516. In case of the marketable entity, company name of a company managing the marketable entity will be provided by the user in the company name field 516.

The title field 518 can be used by the user to provide a designation of the user. The user provides a short bio about himself in the about yourself field 520. The short bio may include information such as number of years of experience in the current field, types of projects handled etc. The user provides the address associated with the user/marketable entity in the address field 522.

The central trigger name field 524 is used by the user to provide a custom name for a central trigger to be provided in the digital business card. The central trigger name field 524 includes a drop down menu with some predefined commonly used central trigger names, such as “Add To Contacts”, “Buy Tickets”, “Make A Reservation”, “Register Today”, “Redeem Offer”, “Browse Attractions” etc. The user can select any name from the listed central trigger names or can create a customized name relevant to a purpose of the digital business card. The central trigger hyperlink field 526 is used by the user to provide a hyperlink associated with the central trigger.

The user may click on the save button 528 to save the personal information provided in the basic information page 502. Once the user clicks the save button 528, the personal information provided by the user in the basic information page 502 will be saved in a database (e.g., the database 120).

FIG. 5B is an example representation of a user interface (UI) 550 depicting an image page 552 of the online questionnaire displayed to a user, such as the user 102 of the progressive web application generation platform 110, in accordance with an example embodiment. The UI 550 is presented on a user device, such as the user device 104 shown in FIG. 1. The image page 552 is used to receive photos and videos associated with the user/marketable entity which will be used by the progressive web application generation platform 110 for creating the digital business card for the user.

The image page 552 includes an add photos field 554, an add videos field 558, an add profile photo/video field 562 field and a save button 566. The add photos field 554 includes an add tab 556. The user can click on the add tab 556 for providing one or more photos. Similarly, the add videos field 558 includes an add tab 560 that is similar to the add tab 556. The user can click on the add tab 560 for providing one or more videos that the user wants to add in the digital business card. The add profile photo/video field 562 includes an add tab 564. The user can click on the add tab 564 to add an audio or a video that the user wants to put as a profile photo/video in the digital business card.

The user may click on the save button 566 to save the photos and videos provided in the image page 552. Once the user clicks the save button 566, the photos and videos provided by the user in the image page 552 will be saved in the database.

The user can provide profile links of the one or more social media platforms associated with the user/marketable entity in the social media link page. For example, the user can provide Facebook™ profile link, Instagram™ profile link, LinkedIn® profile link in the social media link page.

FIG. 5C is an example representation of a user interface (UI) 580 depicting an account management page 582 displayed to a user, such as the user 102 of the progressive web application generation platform 110, in accordance with an example embodiment. The UI 580 is presented on a user device, such as the user device 104 shown in FIG. 1. The account management page 582 is displayed to the user/person when a digital business card is created for the user/marketable entity.

The account management page 582 includes an edit digital business card section 584, a view digital business card section 586 and an installing instruction section 588. The edit digital business card section 584 includes an edit icon 590. Clicking on the edit icon 590 will direct the user/person to an edit page (not shown in figures) where the user/person can edit the user profile information/marketable entity profile information included in the digital business card.

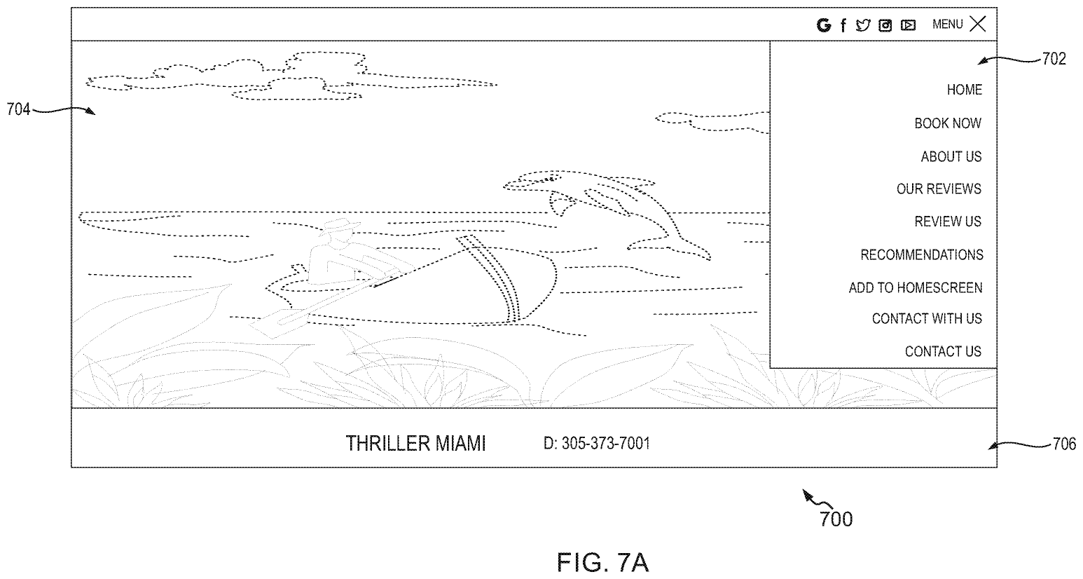

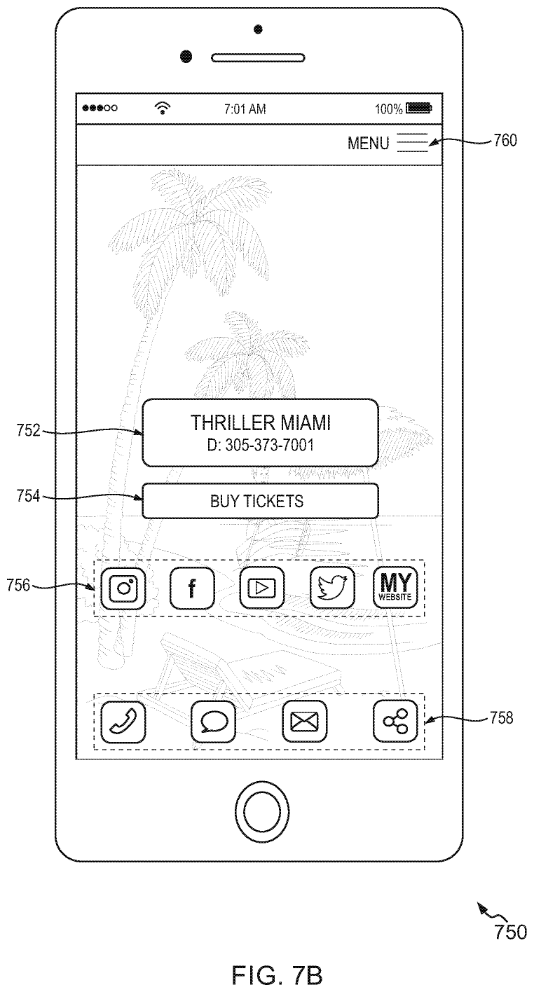

The view digital business card section 586 includes a view on mobile icon 592 and a view on desktop icon 594. Clicking on the mobile icon 592 will display the digital business card in a mobile view (shown in FIG. 7B) and the clicking on the desktop icon 594 will display the digital business card in a desktop view (shown in FIG. 7A). The installing instruction section 588 includes a view instruction con 596 that can be clicked by the user to view instructions for installing the digital business card on the mobile devices.

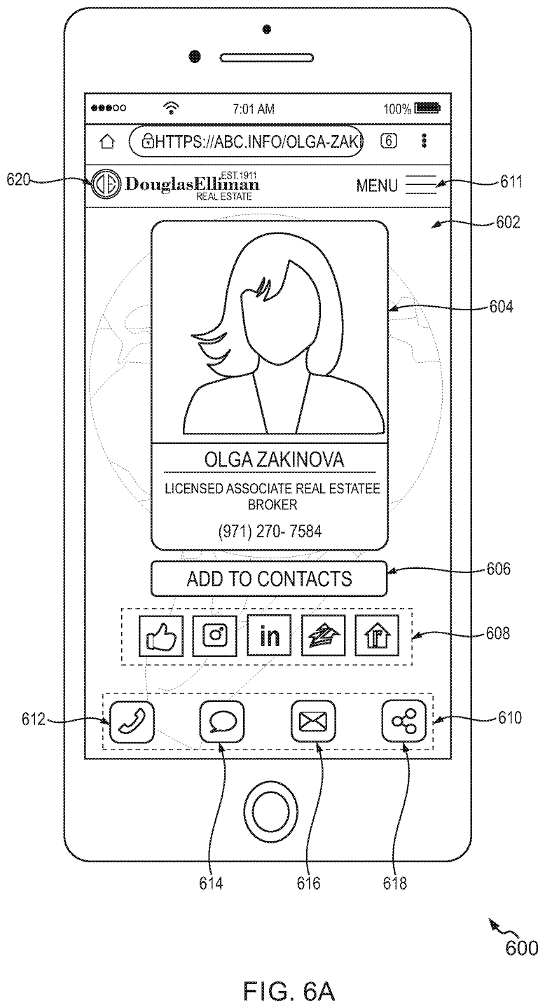

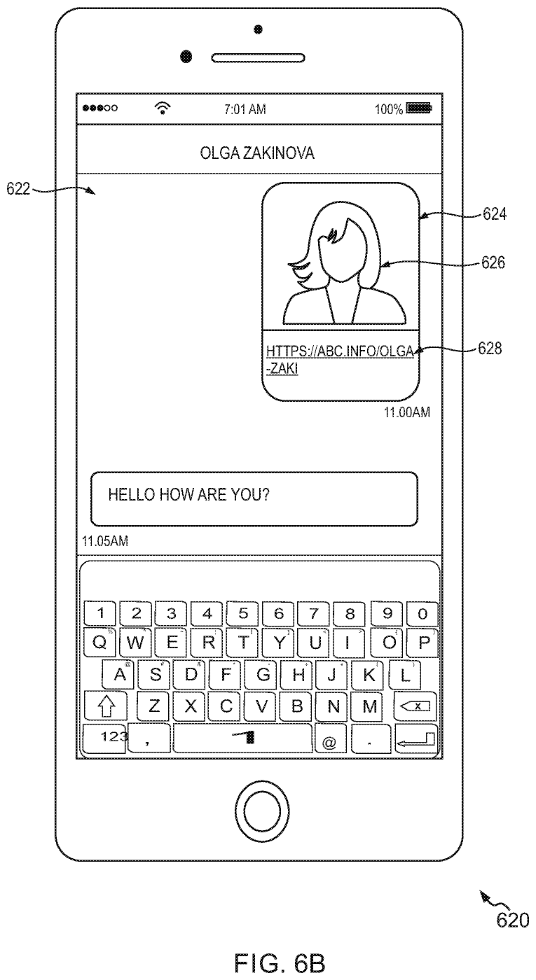

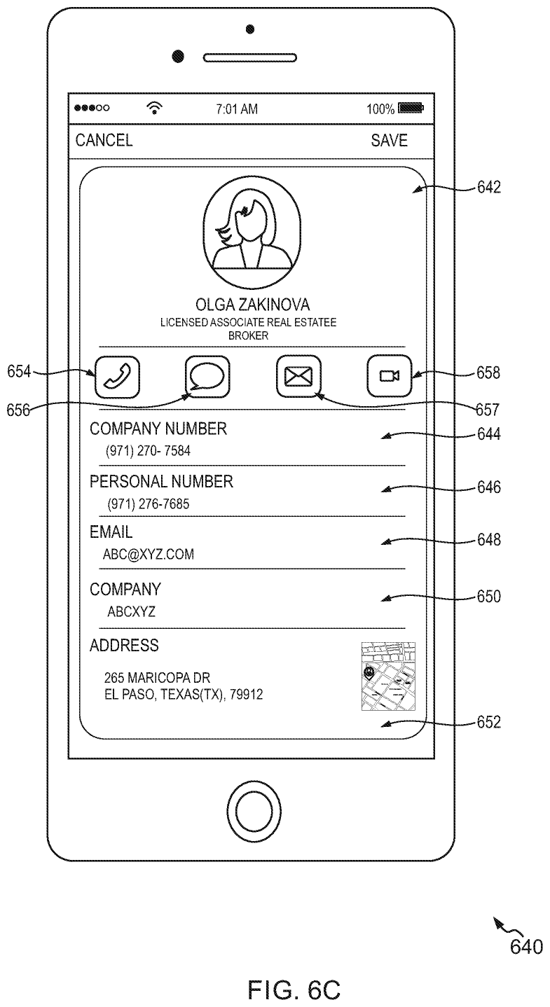

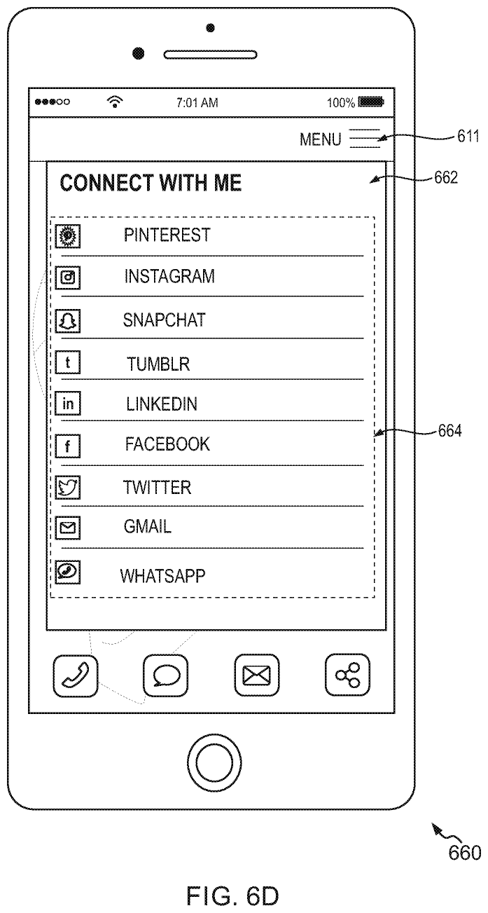

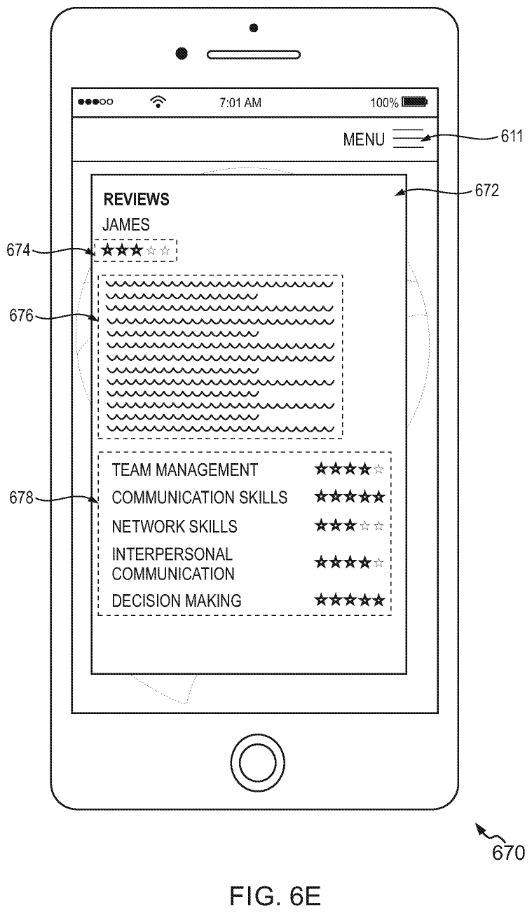

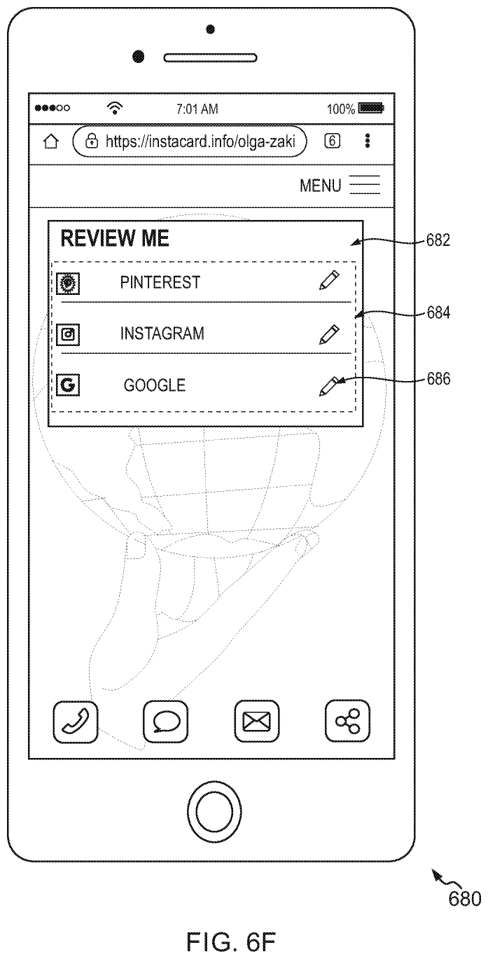

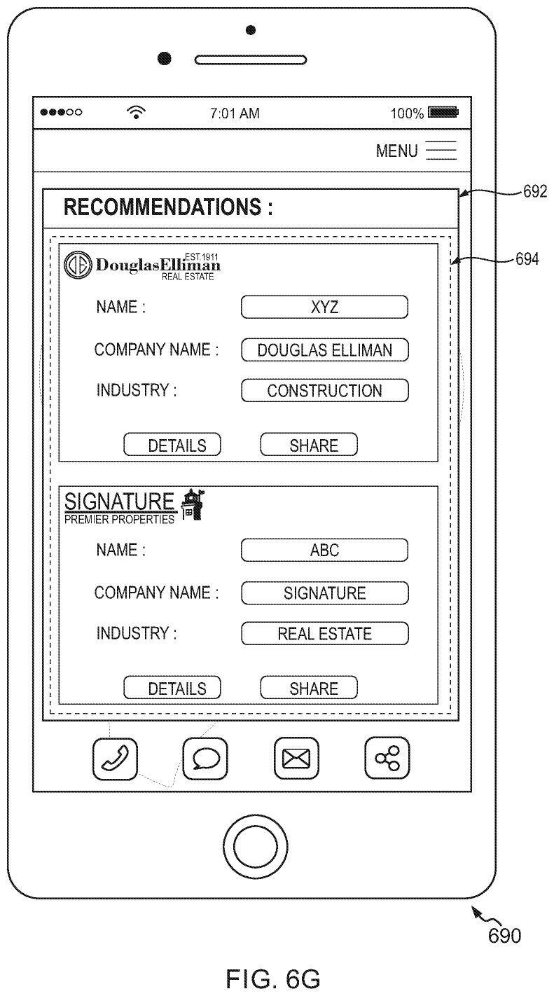

FIG. 6A is an example representation of a UI 600 depicting a digital business card page 602 displayed to a user, such as the user 102 of the progressive web application generation platform 110 and an individual, such as the customer 112, in accordance with an exemplary embodiment of the present disclosure. The UI 600 is presented on electronic devices, such as the user device 104 and the customer device 114 shown in FIG. 1. The digital business card page 602 is displayed to the user once the digital business card is created for the user based on the user profile information provided by the user in an online questionnaire. The digital business card page 602 is also displayed to the individual with whom the user has shared the digital business card.

The digital business card page 602 includes a logo 620 of a company with which the user is working, a personal information section 604, an add to contacts icon 606, a social media link section 608, an action tab section 610 and a menu tab 611. The personal information section 604 displays personal information of the user, such as a name of the user, designation of the user, and contact information of the user. The personal information section 604 also displays a profile photo of the user.

The add to contacts icon 606 may be used by the user/individual for adding the user profile information included in the digital business card as a contact in his/her electronic device. Clicking on the add to contacts icon 606 may redirect the user/individual to a contacts page which is discussed in detail with reference to FIG. 6C. The social media link section 608 displays one or more social media platform icons, such as Facebook™ icon, Instagram™ icon, LinkedIn® icon, Skype® icon etc. Clicking on a social media link icon included in the social media link section 608 may redirect the user to a user profile page of the corresponding social media platform. For example, if the user clicks on the Facebook™ icon, then the user will be redirected to Facebook™ profile page of the user associated with the digital business card.

The action tab section 610 includes a call icon 612, a messaging icon 614, an email icon 616 and a share icon 618. The user can click on the call icon 612 for making a phone call to the user associated with the digital business card. The user can click on the messaging icon 614 for communicating with the user associated with the digital business card over the message. Similarly, the user can click on the email icon 616 for sending an email to the user. The share icon 618 may be used by the user for sharing the digital business card with other individuals. Clicking on the share icon 618 may provide an option to the user to select a platform from one or more platforms that are available in the user device through which the user wants to share the profile. Once the user selects the platform, the user has to select a person with whom the user wants to share the digital business card. Further, a URL associated with the digital business card along with a profile photo is sent to the selected person through the selected platform.

Clicking on the menu tab 611 may provide a list of sub tabs that can be clicked for performing a corresponding operation using the digital business card. In an embodiment, the list of sub tabs may include a connect with me tab, a review me tab, a reviews tab and a recommendation tab. The list of sub tabs is discussed with reference to FIGS. 6D to 6G. The list of sub tabs may also include some general tabs such as home tab, about us tab etc.

FIG. 6B is an example representation of a UI 620 depicting a shared page 622 displayed to an individual, such as the customer 112, in accordance with an exemplary embodiment of the present disclosure. The UI 620 is presented on an electronic device, such as the customer device 114 associated with the individual. The shared page 622 displays how a URL associated with the digital business card is shared by the user to the individual using a message application installed on the user device.

The shared page 622 includes a message section 624 that displays a message received from the user who has shared his digital business card with the individual. The message section 624 displays a photo 626 that is used as a profile photo in the digital business card created for the user and a link 628 included in the photo 626. Clicking on the link 628 may redirect the individual to the digital business card page (shown in FIG. 6A) of the user.

FIG. 6C is an example representation of a UI 640 depicting a contacts page 642 displayed to an individual, such as the customer 112, in accordance with an exemplary embodiment of the present disclosure. The UI 640 is presented on an electronic device, such as the customer device 114 associated with the individual. The contacts page 642 is displayed to the individual when the individual clicks on add to contacts icon 606 provided in the digital business card page 602.

The contacts page 642 includes a company number section 644, a personal number section 646, an email-id section 648, a company name section 650, an address section 652, a call icon 654, a message icon 656, an email icon 657 and a video call icon 658. As the individual clicks on the add to contacts icon 606 provided in the digital business card page 602, the user profile information included in the digital business card is automatically get filled in the sections (644-652). For example, the company number mentioned in the digital business card will be automatically filled in the company number section 644, the personal number mentioned in the digital business card will be automatically filled in the personal number section 646, the email-id mentioned in the digital business card will be automatically filled in the email-id section 648, the company in which the user is currently working will be automatically filled in the company name section 650 and the address of the user mentioned in the digital business card will be automatically filled in the address section 652. The address section 652 also shows the mentioned address in a map. The icons (654-658) can be clicked by the individual for performing different operations, such as the call icon 654 can be clicked for making a call to the user, the message icon 656 can be clicked for writing a message to the user, the email icon 657 can be clicked for writing an email to the user, and the video call icon 658 can be clicked for making a video call to the user.

FIG. 6D is an example representation of a UI 660 depicting a connect with me page 662 displayed to an individual, such as the customer 112, in accordance with an exemplary embodiment of the present disclosure. The UI 660 is presented on an electronic device, such as the customer device 114 associated with the individual. The connect with me page 662 is displayed to the individual when the individual clicks on the connect with me tab provided in the menu tab 611 of the digital business card page 602.

The connect with me page 662 includes a list 664 containing one or more social media icons. Each social media icon is displayed along with a name of a corresponding social media platform. Clicking on each social media icon may redirect the individual to a user profile page of the corresponding social media platform. The individual can now get connected with the user on different social media platforms.

FIG. 6E is an example representation of a UI 670 depicting a review page 672 displayed to an individual, such as the customer 112, in accordance with an exemplary embodiment of the present disclosure. The UI 670 is presented on an electronic device, such as the customer device 114 associated with the individual. The review page 672 is displayed to the individual when the individual clicks on the review tab provided in the menu tab 611 of the digital business card page 602.

The review page 672 displays one or more reviews posted for the user by the one or more individuals on the different social media platforms. Each individual may have provided an overall rating to the user that is displayed in a rating section 674. The experience of working with the user described by the individual is displayed in a content section 676. The individual may have rated the user on different skills and the different skill ratings provided by the individual are displayed in a skill rating section 678.

FIG. 6F is an example representation of a UI 680 depicting a review me page 682 displayed to an individual, such as the customer 112, in accordance with an exemplary embodiment of the present disclosure. The UI 680 is presented on an electronic device, such as the customer device 114 associated with the individual. The review me page 682 is displayed to the individual when the individual clicks on the review me tab provided in the menu tab 611 of the digital business card page 602.

The review me page 682 displays a list 684 containing one or more social media platform names. Each social media platform name is displayed along with a write icon e.g., a write icon 686. Clicking on the write icon corresponding to a social media platform may redirect the individual to a write review section provided in a user profile page of the social media platform. The individual can now write reviews about the user in the write review section in the user profile page of the social media platform. For example, the individual can click on the write icon 686 to write reviews about the user in a Google profile of the user.

FIG. 6G is an example representation of a UI 690 depicting a recommendations page 692 displayed to an individual, such as the customer 112, in accordance with an exemplary embodiment of the present disclosure. The UI 690 is presented on an electronic device, such as the customer device 114 associated with the individual. The recommendations page 692 is displayed to the individual when the individual clicks on a recommendation tab provided in the menu tab 611 of the digital business card page 602.

The recommendations page 692 displays a list of marketable entities 694 that the user wants to recommend. For example, the digital business card associated with a real estate agent may include recommendations for a reliable mortgage specialist, an assessor, an inspection specialist, a construction company, an electrician, a plumber, a movers & packers and so on. As shown in the FIG. 6G, the list of marketable entities 694 includes two marketable entities column. Each column include details, such as a logo associated with marketable entity, a name of the marketable entity, a company name and category/industry associated with the marketable entity. Each column also includes a details button and a share button. Clicking on the details button will display additional details, such as contact number and email-id associated with the marketable entity. Clicking on the share button will allow the user to share a profile associated with the marketable entity with other users.

FIG. 7A is an example representation 700 of a digital business card created for a marketable entity, such as a company, in accordance with an exemplary embodiment of the present disclosure. The digital business card is displayed in a desktop view to one or more persons handling the marketable entity and one or more individuals, such as the customer 112 with whom the digital business card is being shared. The digital business card is displayed once the digital business card is created for the marketable entity based on the marketable entity profile information provided by the one or more persons handling the marketable entity.

The representation 700 of the digital business card includes a menu section 702, a background section 704 and a details section 706. The menu section 702 displays one or more tabs, such as a add to home screen tab, a reviews tab etc. The individual can click on the add to home screen tab for installing the digital business card on his/her electronic device. The background section 704 displays a profile photo/video associated with the marketable entity. The details section 706 displays the details, such as contact number associated with the marketable entity.

FIG. 7B is an example representation 750 of the digital business card displayed in a mobile view, in accordance with an exemplary embodiment of the present disclosure. The representation 750 includes an information section 752, a buy tickets icon 754, a social media link section 756, an action tab section 758 and a menu tab 760. The information section 752 displays information associated with the marketable entity, such as a name of the marketable entity i.e. ‘Thriller Miami’, and contact information of the marketable entity i.e. ‘305-373-7001’.

Clicking on the buy tickets icon 754 will redirect the individual to a tickets page from where the individual can book tickets. The social media link section 756 displays one or more social media platform icons, such as Facebook™ icon, Instagram™ icon etc. Clicking on a social media link icon included in the social media link section 756 may redirect the individual to a marketable entity profile page i.e. Thriller Miami page of the corresponding social media platform. The action tab section 758 is similar to the action tab 610 and the menu tab 760 is similar to the menu tab 611 discussed with reference to FIG. 6A.

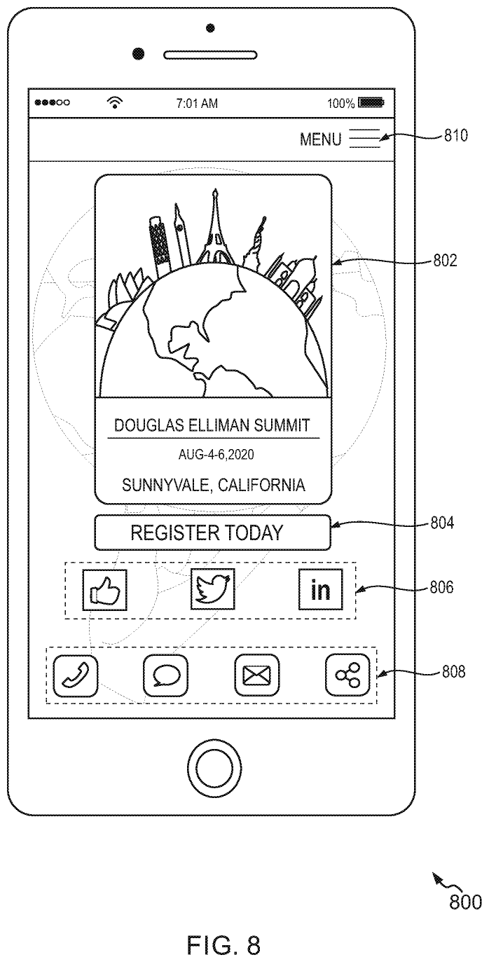

FIG. 8 is an example representation 800 of a digital business card created for another marketable entity, such as an event, in accordance with an exemplary embodiment of the present disclosure. The digital business card is displayed to one or more persons handling the marketable entity and one or more individuals, such as the customer 112 with whom the digital business card is being shared. The digital business card is displayed once the digital business card is created for the marketable entity based on the marketable entity profile information provided by the one or more persons handling the marketable entity.

The representation 800 includes an information section 802, a register today icon 804, a social media link section 806, an action tab section 808 and a menu tab 810. The information section 802 displays information associated with the event, such as a name of the event i.e. ‘Douglas Elliman Summit’, date of the event i.e. from ‘Aug. 4 to Aug. 6, 2020’ and location of the event i.e. ‘Sunnyvale, Calif.’.

Clicking on the register today icon 804 will redirect the individual to a registration page from where the individual can register for the event. The social media link section 806 displays one or more social media platform icons, such as Facebook™ icon, Twitter™ icon etc. The action tab section 808 is similar to the action tab 610 and the menu tab 810 is similar to the menu tab 611 discussed with reference to FIG. 6A.

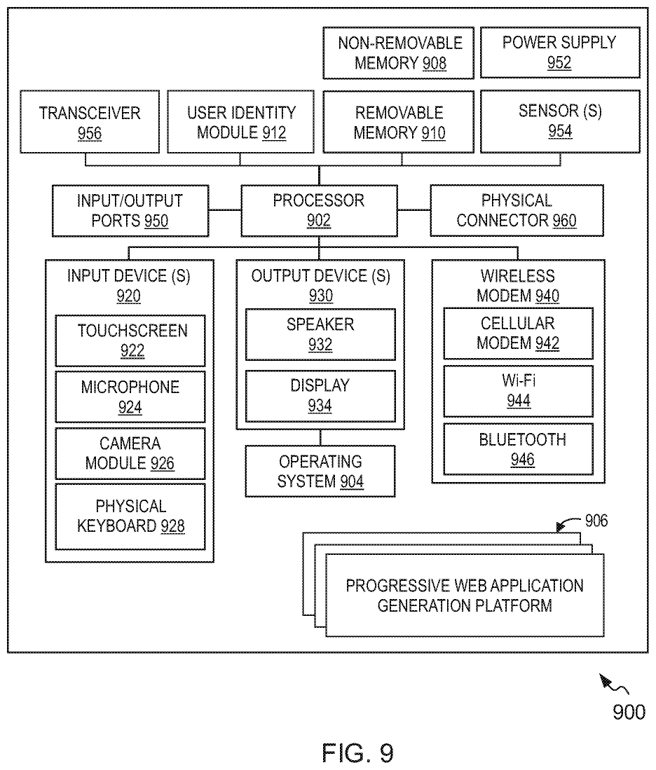

FIG. 9 shows a simplified block diagram of an electronic device 900 capable of implementing the various embodiments of the present disclosure. The electronic device 900 may be an example of the electronic devices 104 and 114. It should be understood that the electronic device 900 as illustrated and hereinafter described is merely illustrative of one type of device and should not be taken to limit the scope of the embodiments. As such, it should be appreciated that at least some of the components described below in connection with the electronic device 900 may be optional and thus in an example embodiment may include more, less or different components than those described in connection with the example embodiment of the FIG. 9. As such, among other examples, the electronic device 900 could be any of an electronic device or may be embodied in any of the electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 900 includes a controller or a processor 902 (e.g., a signal processor, microprocessor, ASIC, or other control and processing logic circuitry) for performing such tasks as signal coding, data processing, image processing, input/output processing, power control, and/or other functions. An operating system 904 controls the allocation and usage of the components of the electronic device 900 and provides support for one or more programs, such as the progressive web application generation platform that implements one or more of the innovative features described herein. The applications 906 may include common mobile computing applications (e.g., telephony applications, email applications, calendars, contact managers, web browsers, messaging applications such as USSD messaging or SMS messaging or SIM Tool Kit (STK) application) or any other computing application.

The illustrated electronic device 900 includes one or more memory components, for example, a non-removable memory 908 and/or a removable memory 910. The non-removable memory 908 and/or the removable memory 910 may be collectively known as storage device/module in an embodiment. The non-removable memory 908 can include RAM, ROM, flash memory, a hard disk, or other well-known memory storage technologies. The removable memory 910 can include flash memory, smart cards, or a Subscriber Identity Module (SIM). The one or more memory components can be used for storing data and/or code for running the operating system 904. The electronic device 900 may further include a user identity module (UIM) 912. The UIM 912 may be a memory device having a processor built in. The UIM 912 may include, for example, a subscriber identity module (SIM), a universal integrated circuit card (UICC), a universal subscriber identity module (USIM), a removable user identity module (R-UIM), or any other smart card. The UIM 912 typically stores information elements related to a mobile subscriber. The UIM 912 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 900 can support one or more input devices 920 and one or more output devices 930. Examples of the input devices 920 may include, but are not limited to, a touch screen/a display screen 922 (e.g., capable of capturing finger tap inputs, finger gesture inputs, multi-finger tap inputs, multi-finger gesture inputs, or keystroke inputs from a virtual keyboard or keypad), a microphone 924 (e.g., capable of capturing voice input), a camera module 926 (e.g., capable of capturing still picture images and/or video images) and a physical keyboard 928. Examples of the output devices 930 may include, but are not limited to, a speaker 932 and a display 934. Other possible output devices can include piezoelectric or other haptic output devices. Some devices can serve more than one input/output function. For example, the touch screen 922 and the display 934 can be combined into a single input/output device.

A wireless modem 940 can be coupled to one or more antennas (not shown in the FIG. 9) and can support two-way communications between the processor 902 and external devices, as is well understood in the art. The wireless modem 940 is shown generically and can include, for example, a cellular modem 942 for communicating at long range with the mobile communication network, a Wi-Fi compatible modem 944 for communicating at short range with an external Bluetooth-equipped device or a local wireless data network or router, and/or a Bluetooth-compatible modem 946. The wireless modem 940 is typically configured for communication with one or more cellular networks, such as a GSM network for data and voice communications within a single cellular network, between cellular networks, or between the electronic device 900 and a public switched telephone network (PSTN).

The electronic device 900 can further include one or more input/output ports 950, a power supply 952, one or more sensors 954 for example, an accelerometer, a gyroscope, a compass, or an infrared proximity sensor for detecting the orientation or motion of the electronic device 900, a transceiver 956 (for wirelessly transmitting analog or digital signals) and/or a physical connector 960, which can be a USB port, IEEE 1294 (FireWire) port, and/or RS-232 port. The illustrated components are not required or all-inclusive, as any of the components shown can be deleted and other components can be added.

The disclosed systems and methods with reference to FIGS. 1 to 9, or one or more operations of the method 300 and the method 400 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

FIG. 10 is a simplified block diagram of a server system 1000, in which the progressive web application generation platform 110 is provided, in accordance with one embodiment of the present disclosure. The server system 1000 is an example of the server 108 shown and explained with reference to FIG. 1. The server system 1000 includes a computer system 1005 and one or more databases, such as a database 1010.

The computer system 1005 includes a processor 1015 for executing instructions. Instructions may be stored in, for example, but not limited to, a memory 1020. The processor 1015 may include one or more processing units (e.g., in a multi-core configuration). The processor 1015 is operatively coupled to a communication interface 1025 such that the computer system 1005 is capable of communicating with a remote device such as an electronic device 1035. Example of the electronic device 1035 may include, but is not limited to, the electronic devices 104 and 114 shown in FIG. 1.

The processor 1015 may also be operatively coupled to the database 1010. The database 1010 is configured to store user profile information associated with each user as explained with reference to FIGS. 1 to 9. The database 1010 is any computer-operated hardware suitable for storing and/or retrieving data. The database 1010 may include multiple storage units such as hard disks and/or solid-state disks in a redundant array of inexpensive disks (RAID) configuration. The database 1010 may include, but not limited to, a storage area network (SAN) and/or a network attached storage (NAS) system.

In some embodiments, the database 1010 is integrated within the computer system 1005. For example, the computer system 1005 may include one or more hard disk drives as the database 1010. In other embodiments, the database 1010 is external to the computer system 1005 and may be accessed by the computer system 1005 using a storage interface 1030. The storage interface 1030 is any component capable of providing the processor 1015 with access to the database 1010. The storage interface 1030 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1015 with access to the database 1010.

The memory 1020 is a storage device embodied as one or more volatile memory devices, one or more non-volatile memory devices, and/or a combination of one or more volatile memory devices and non-volatile memory devices, for storing micro-contents information and instructions. The memory 1020 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), flash ROM, RAM (random access memory), etc.).

Various example embodiments offer, among other benefits, techniques for establishing methods and systems for creating a digital business card in form of a progressive web application. The system generates the digital business card in form of the progressive web pages, thereby eliminating the need to download the progressive web application generation platform for viewing the digital business card and the need of having a network connectivity for viewing the digital business card. The system generates digital business card, thereby eliminating the need of paper printed business card which further saves paper and the cost associated with printing the paper business card. The system provides an add to contact option for saving the user profile information included in the digital business card as a contact in the mobile device, thereby facilitating use of normal phone functions which a user is accustomed to. The system also adds Search Engine Optimization (SEO) value to an online reputation of the professionals, companies and other marketable entities.

Although the invention has been described with reference to specific exemplary embodiments, it is noted that various modifications and changes may be made to these embodiments without departing from the broad spirit and scope of the invention. For example, the various operations, blocks, etc. described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

The present disclosure is described above with reference to block diagrams and flowchart illustrations of method and system embodying the present disclosure. It will be understood that various blocks of the block diagram and flowchart illustrations, and combinations of blocks in the block diagrams and flowchart illustrations, respectively, may be implemented by a set of computer program instructions. These set of instructions may be loaded onto a general-purpose computer, special purpose computer, or other programmable data processing apparatus to cause a device, such that the set of instructions when executed on the computer or other programmable data processing apparatus creates a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory medium or means that can contain, store, communicate, propagate or transport the instructions for use by or in connection with an instruction execution system, apparatus, or device, such as a computer. A computer-readable medium may include a computer-readable storage medium that may be any medium or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such are intended to cover the application and\or implementation without departing from the spirit or scope of the claims.

What is claimed is:

1. A method, comprising:
receiving, by a processor, user profile information, the user profile information comprising personal information and one or more of: one or more social media links; one or more photos; and one or more videos;
creating, by the processor, a digital business card for a user based on the received user profile information, wherein the digital business card is a microsite created in form of one or more progressive web pages; and
facilitating, by the processor, sharing of the digital business card with one or more individuals by the user.

2. The method as claimed in claim 1, further comprising:
storing, by the processor, the user profile information in a database.

3. The method as claimed in claim 1, further comprising:
receiving, by the processor, a request to view the digital business card from a mobile device associated with an individual; and
upon receiving the request, displaying, by the processor, the digital business card on the mobile device associated with the individual.

4. The method as claimed in claim 3, wherein displaying the digital business card comprises:
allowing, by the processor, one or more actions to be performed on the digital business card by the individual.

5. The method as claimed in claim 4, wherein the one or more actions comprise:
accessing the one or more social media links included in the digital business card;
adding the digital business card as a contact on the mobile device;
sharing the digital business card;
sending a text to the user;
making a call to the user;
sending an e-mail to the user; and
writing and viewing reviews.

6. The method as claimed in claim 5, wherein the user profile information included in the digital business card is added in contact information while adding the digital business card as the contact on the mobile device.

7. The method as claimed in claim 1, wherein the digital business card is shared by the user with each individual of the one or more individuals in an access mode.

8. The method as claimed in claim 7, wherein the access mode is one of: a private mode; and a public mode.

9. A server system, comprising:
a memory configured to store instructions; and
a processor configured to execute the instructions stored in the memory and thereby cause the server system to at least:
receiving user profile information, the user profile information comprising personal information and one or more of: one or more social media links; one or more photos; and one or more videos;
creating a digital business card for a user based on the received user profile information, wherein the digital business card is a microsite created in form of one or more progressive web pages; and
facilitating sharing of the digital business card with one or more individuals by the user.

10. The server system as claimed in claim 9, wherein the server system is further caused at least in part to:
store the user profile information in a database.

11. The server system as claimed in claim 9, wherein the server system is further caused at least in part to:
receive a request to view the digital business card from a mobile device associated with an individual; and
upon receiving the request, display the digital business card on the mobile device associated with the individual.

12. The server system as claimed in claim 11, wherein for displaying the digital business card, the server system is further caused at least in part to:
enable one or more actions to be performed on the digital business card by the individual.

13. The server system as claimed in claim 12, wherein the one or more actions comprises:
accessing the one or more social media links included in the digital business card;
adding the digital business card as a contact on the mobile device;
sharing the digital business card;
sending a text to the user;
making a call to the user;
sending an e-mail to the user; and
writing and viewing reviews.

14. The server system as claimed in claim 9, wherein the digital business card is shared by the user with each individual of the one or more individuals in an access mode.

15. The server system as claimed in claim 14, wherein the access mode is one of: a private mode; and a public mode.

16. A method, comprising:
receiving, by a processor, marketable entity profile information, the marketable entity profile information comprising marketable entity information, and one or more of: one or more social media links associated with a marketable entity; one or more photos associated with the marketable entity; and one or more videos associated with the marketable entity;
creating, by the processor, a digital business card based on the marketable entity profile information, wherein the digital business card is a microsite created in form of one or more progressive web pages; and
facilitating, by the processor, sharing of the digital business card with one or more individuals by one or more persons handling the marketable entity.

17. The method as claimed in claim 16, further comprising:
storing, by the processor, the marketable entity profile information associated with the marketable entity in a database.

18. The method as claimed in claim 16, further comprising:
receiving, by the processor, a request to view the digital business card from a mobile device associated with an individual; and
upon receiving the request, displaying, by the processor, the digital business card on the mobile device associated with the individual.

19. The method as claimed in claim 18, wherein displaying the digital business card comprises:
allowing, by the processor, one or more actions to be performed on the digital business card by the individual, wherein the one or more actions depends on the marketable entity.

20. The method as claimed in claim 16, wherein the digital business card is shared by a person with each individual of the one or more individuals in an access mode, wherein the access mode is one of: a private mode; and a public mode.
